(19) United States
(12) Patent Application Publication
(10) Pub. No.: US 2017/0200241 A1
(43) Pub. Date: Jul. 13, 2017

(54) GAS MANAGEMENT SYSTEM

(71) Applicant: Nippon Gas Co., Ltd., Tokyo (JP)

(72) Inventors: Shinji Wada, Tokyo (JP); Shingo Dekamo, Tokyo (JP)

(21) Appl. No.: 15/467,897

(22) Filed: Mar. 23, 2017

Related U.S. Application Data
(63) Continuation-in-part of application No. 14/764,822, filed on Jul. 30, 2015.

(30) Foreign Application Priority Data
Jan. 31, 2013 (JP) 2013-017792

(51) Int. Cl. G06Q 50/06; G06Q 50/26; G06Q 30/02

(52) U.S. Cl. CPC G06Q 50/06; G06Q 30/0283; G06Q 50/265

(57) ABSTRACT

An operation unit price is obtained based on a second database in which information on a customer is stored and a third database in which information on an operation unit price specified for each operator organization to which an operator belongs and for each content of the operation performed by the operator is stored. A fourth database in which information on an operation cost to be paid to the operation organization by the gas supplier is stored is updated based on a first database in which information on the operator is stored and the operation unit price obtained. The operation costs are totalized based on the fourth database. The operation cost is totalized.

### CROSS-REFERENCE TO RELATED APPLICATIONS

This application is a continuation-in-part application of U.S. patent application Ser. No. 14/764,822 under 37 Code of Federal Regulations §1.53 (b) and said US application which is a US national phase of PCT Application No. PCT/JP2014/000529 filed on Jan. 31, 2014 claims the benefit of Japanese Patent application No. 2013-017792 filed on Jan. 31, 2013, which are hereby incorporated by reference in their entirety.

### TECHNICAL FIELD

The present invention relates to a gas management system and an automatic operation cost calculation method.

### BACKGROUND ART

LP gas is classified into imports from gas producing countries and domestic production including by-products from production processes of petroleum products. Import terminals where LP gas carried from gas producing countries by tankers is stored and petroleum refinery terminals are referred to as primary terminals. LP gas is loaded into domestic vessels or tank trucks at a primary terminal and shipped to secondary terminals that are transit stations for LP gas transportation which are located seacoast or inland. Then, the LP gas carried to a secondary terminal is transported to LP gas filling stations in various locations (delivery bases), where gas cylinders are filled with the LP gas. The gas cylinders filled with the LP gas at the delivery bases are delivered by deliverymen to customers such as general homes, housing complexes, and business offices. This is a supply method using gas cylinders. Another supply method is a supply method to use gas bulks. In this method, gas bulks installed at customers are directly filled with gas via tank trucks. The gas cylinders and the gas bulks are hereinafter sometimes collectively referred to as “gas cylinders”.

On the other hand, the LP gas supplied by these methods may cause gas leakage, explosion, or the like, creating pollution. Thus, Japan has enacted a law mainly intended to ensure safety against pollution, to prevent pollution, and to allow appropriate transactions of LP gas, to oblige gas suppliers to periodically inspect gas supply facilities and gas consumption facilities for LP gas. The gas supply facility refers to a connection from a gas cylinder to an outlet of a meter, and gas suppliers are obliged to periodically inspect the gas supply facilities as part of the companies' own responsibility for management. Furthermore, the gas consumption facility refers to a connection from the outlet of the meter to each gas equipment (for example, a gas stove or a water heater). The customer takes responsibility for managing the gas consumption facility, but the gas supplier is obliged to periodically inspect the gas consumption facility as is the case with the gas supply facility.

Two types of laws have been enacted to mandate the periodic inspections, that is, “Act Concerning the Securing of Safety and the Optimization of Transaction of Liquefied Petroleum Gas” (hereinafter referred to as the “Liquefied Petroleum Gas Act”) and “Gas Business Act”. The laws are distinguished from each other according to a supply method. The Liquefied Petroleum Gas Act is specified for a supply method in which LP gas is directly supplied by, for example, delivering cylinders to customers (hereinafter referred to as “general supply”) and a supply method in which a simple gas generator also referred to as a gas facility is installed to vaporize LP gas so that the resultant gas is supplied to a plurality of customers through pipelines. However, the Liquefied Petroleum Gas Act is applicable to a scale of less than 70 supply destinations, that is, less than 70 customers. For a scale of 70 customers or more, the Gas Business Act is applicable. Thus, despite the use of the same facility, the applicable law varies depending on the customer supply scale. The supply method to which the Liquefied Petroleum Gas Act is applied is distinguished from the same supply method to which the Gas Business Act is applied; the former is referred to as “concentric gas (supply)”, while the latter is referred to as “community gas (supply)”.

The Liquefied Petroleum Gas Act requires that the gas supply facilities and gas consumption facilities for gas cylinders be periodically inspected every four years. This periodic inspection includes piping inspection in which gas pipes are inspected, and for white gas pipes (outdated plated gas pipes), which are prone to corrosion, in principle, yearly piping inspection is mandated. Moreover, gas bulks may need to be inspected in a shorter period such as six months or one year. Furthermore, for the gas consumption facilities, it is mandatory that, if the necessity to re-inspect the facility is determined as a result of the periodic inspection, the re-inspection is carried out one month after the date of inspection and within six months of the date. The re-inspection is limited to the gas consumption facilities because the gas consumption facility is owned by the customer and the gas supplier is only allowed to urge the customer to take corrective action, so that the gas supplier carries out re-inspection after the given period. Upon finding, at the time of the re-inspection, that the customer has failed to take the corrective action and determining that continuous supply is risky, the gas supplier may take what is called a closing cock measure to stop the supply of gas. On the other hand, the gas supply facility is owned by the gas supplier, and if re-inspection is needed, the inspection is immediately performed, and thus, the Liquefied Petroleum Gas Act specifies no specific period.

The Gas Business Act requires that the gas consumption facility be periodically inspected every 40 months. For the periodic inspection of the gas facilities, which are gas supply facilities, the period varies in accordance with a facility level. More specifically, the inspection is conducted every day for facilities adopting a method of forcibly vaporizing LP gas using electricity or gas, every month for facilities with automatic monitoring apparatuses, and every week for the other facilities. Furthermore, for the gas consumption facilities, it is mandatory to conduct re-inspection one month after the date of inspection and within six months of the date, as is the case with the Liquefied Petroleum Gas Act. Moreover, for the gas supply facilities, it is mandatory to conduct a pipeline leakage inspection every 40 months. Pipelines refer to those of the gas pipes used for community gas supply which are buried parallel to roads (in contrast, gas pipes from pipelines to customers are hereinafter referred to as “supply pipes”).

Moreover, besides the above-described inspections, periodic replacement of components such as a gas alarm device and a gas meter, a regulator, and a gas hose are carried out, and management and needed operation are performed on the components. In particular, the gas supply involves many types of components, which have different lifetimes. The components need to be replaced before the lifetimes expire.

### CITATION LIST

### Patent Literature

PTL 1: Japanese Patent Laid-Open No. 2008-117247

### SUMMARY OF INVENTION

As described above, various inspections of the gas supply facilities and gas consumption facilities for LP gas and various component replacement are carried out. Some of the above-described safety operations are performed by the gas suppliers, and some of the safety operations are performed by external professional companies to which the gas suppliers commission the safety operations. Normally, the gas supplier has sales offices in different districts, and the sales offices form alliances with commissioned companies, and the unit price of the safety operation paid to the commissioned company by the gas supplier is different depend on the commissioned company. In other words, the operation cost of the safety operation is different depend on the district and the commissioned company.

The gas supplier needs to periodically (for example, every month) pay the operation costs of the safety operations to the commissioned companies. Conventionally, a safety inspector from the commissioned company totalizes operation man-hours for every safety operation, and the commissioned company manually calculates the operation cost. However, the sales office does not check the actual operation man-hours, and accepts data on the totalized and demanded amount provided by the commissioned company and pays the demanded amount.

Now, a conventional process for calculating the operation cost when the gas supplier pays the operation cost to the commissioned company will be described below. First, the safety inspector visits the customer and performs a safety operation (step 1). Upon finishing the safety operation, the safety instructor returns to the commissioned company and reports the content of the operation (step 2). A staff member in the commissioned company references a table of operation cost unit prices specified for each commissioned company and for the respective contents of operations to manually calculate the operation cost corresponding to the operation reported by the safety inspector (step 3). When demanding the operation cost to the gas supplier (for example, every month), the commissioned company calculates the operation costs for all the man-hours of all the safety inspectors during the corresponding period and bills the gas supplier (step 4). A sales staff member in the sales office of the gas supplier inputs the demanded amount to a gas management system (step 5). For the actual payment, the sales staff member inputs a request to output a payment notice to the gas management system (step 6). The payment notice is issued to each commissioned company, and thus, the total amount of the operation costs is calculated for each commissioned company. The gas management system totalizes the operation costs for the commissioned company in accordance with the request and outputs the payment notice (step 7). The sales staff member mails the payment notice to the commissioned company (step 8).

A system that allows for efficient collection of gas costs under the above-described mechanism has been proposed (see PTL 1).

Although a system allowing for efficient collection of gas costs is conventionally available as disclosed in PTL 1, no system is available which automatically calculates the operation costs of safety operations in accordance with the unit prices specified for each commissioned company and which then outputs a payment notice.

In the conventional process, the safety inspector, upon finishing the safety operation, returns to the commissioned company to report the content of the operation, and the staff member in the commissioned company manually calculates the operation cost based on the content of the operation. Thus, a very heavy burden is imposed on the staff member. Furthermore, since the sales office of the gas supplier, which pays the operation costs, fails to check the actual man-hours and accepts the data on the totalized and demanded amount provided by the commissioned company to pay the demanded amount, the operation costs to be paid may be different from the actually paid operation costs. Moreover, there is a time difference from the time of completion of the safety operation to the time of calculation of the date of the operation, omission of the report of the content of the operation, omission of a calculation operation for the operation cost, and the like may occur, and mistakes may result from the manual calculations.

Under this background, a mechanism is desired which allows the operation cost to be accurately calculated for each safety operation immediately after the safety inspector completes the safety operation without the need for the staff member's calculation operation.

With this situation in view, the object of the present invention is to provide a gas management system and a method for automatically calculating an operation cost in which, when a safety inspector from an external commissioned company performs a safety operation, the safety inspector can input the content of the operation via a mobile terminal to obtain an operation unit price based on the content of the operation and in which, at the time of payment, a staff member in a sales office can automatically calculate the operation cost for each commissioned company.

To achieve this object, the present invention provides a gas management system that is a computer system connected to one or more communication terminals via a network to calculate a cost of a gas safety operation to be paid by a gas supplier, the system including display part displayed on display sections of the one or more communication terminals to generate an input interface screen, the input interface screen including a first screen for accepting an input of an operator ID used to identify information on an operator who performs a safety operation for the gas supplier, a second screen for accepting an input of a customer ID used to identify information on a customer who receives a gas supply, and a third screen that accepts an input of operation information used to identify a content of the operation by the operator; input part for receiving, from the one or more communication terminals, the operation ID input via the first screen, the customer ID input via the second screen, and the operation information input via the third screen; a first database in which information on the operator is stored; a second database in which information on the customer is stored; a third database in which information on an operation unit price specified for each operator organization to which the operator belongs and for each content of the operation performed by the operator is stored; a fourth database in which information on an operation cost to be paid to the operation organization by the gas supplier is stored; operation unit price obtaining part for obtaining an operation unit price based on the second database and the third database in accordance with the input of the operation information input via the third screen; operation cost update part for updating the fourth database based on the first database and the obtained operation unit price in accordance with the input of the operation information input via the third screen; and operation cost totalizing part for totalizing the operation cost based on the fourth database in accordance with the input of the operation information input via the third screen.

According to the present invention, for the totalization of the operation cost conventionally manually performed, when the operator ID, the customer ID, and the content of the safety operation are simply input to the gas management system via the communication terminal, the gas management system obtains the operation unit price for each operation to calculate the operation cost based on the man-hours of the operation and adds up the operation costs for each operation year and month for management. Thus, when the operation costs are paid, a request to issue a payment notice is input to allow issuance of a payment notice indicative of the operation costs totalized based on a predetermined unit.

### BRIEF DESCRIPTION OF DRAWINGS

FIG. 1 is a diagram depicting a configuration example of a gas management system according to an embodiment of the present invention;

FIG. 2 is a block diagram depicting details of the gas management system according to the embodiment of the present invention;

FIG. 3 is a diagram depicting an example of a staff member data table according to the embodiment of the present invention;

FIG. 4 is a diagram depicting an example of a customer data table according to the embodiment of the present invention;

FIG. 5 is a diagram depicting an example of an operation unit price data table according to the embodiment of the present invention;

FIG. 6 is a diagram depicting an example of an operation cost data table according to the embodiment of the present invention;

FIG. 7 is a diagram depicting an example of a sales office data table according to the embodiment of the present invention;

FIG. 8 is a flowchart illustrating an example of an operation cost calculating process according to the embodiment of the present invention;

FIG. 9 is a flowchart illustrating an example of a payment notice outputting process according to the embodiment of the present invention; and

FIG. 10 is a diagram depicting an example of a safety operation input menu displayed on a screen of a mobile terminal according to the embodiment of the present invention.

### DESCRIPTION OF EMBODIMENTS

With reference to the attached drawings, a gas management system according to an embodiment of the present invention will be described below in detail.

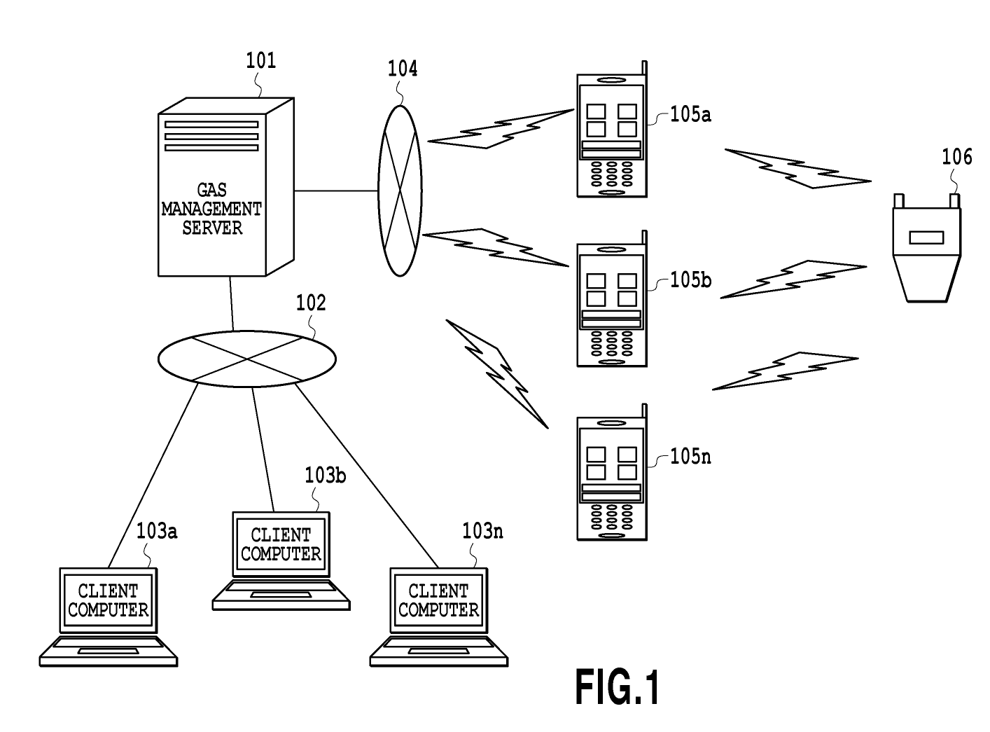

FIG. 1 is a diagram depicting a network configuration of the gas management system according to the embodiment of the present invention. In FIG. 1, a gas management server 101 installed, for example, in a data center is configured to communicate with a plurality of mobile terminals 105a, 105b, . . . , 105n (hereinafter referred to as a “mobile terminal 105”) via a plurality of client computers 103a, 103b, . . . , 103n (hereinafter referred to as a “client computer 103”) installed, for example, in respective sales offices. The mobile terminal 105 is carried by a person such as a safety inspector who performs a safety operation. Furthermore, the mobile terminal 105 is configured to read a two-dimensional code attached to a gas consumption facility 106.

The client computer 103 is a terminal to which a staff member in each sales office of a gas supplier inputs a request to output a payment notice to be sent to each commissioned company when paying operation costs to the commissioned company. At the time of payment, the staff member in the sales office inputs a sales office code via a screen of the client computer 103 and depresses a payment notice output button to output payment notices each indicative of operation costs for a corresponding one of all the commissioned companies under the control of the sales office. In the present embodiment, the safety inspector inputs the content of the safety operation using the mobile terminal 105, and the output of the payment notice is requested using the client computer 103. However, the present embodiment is not limited to this form. For example, the mobile terminal 105 may also be provided with a payment notice output menu via which the request to output the payment notice is input.

A two-dimensional code read application and a menu display application are pre-installed in the mobile terminal 105. For example, in an embodiment, the two-dimensional code read application, when initiated, displays a read screen for two-dimensional codes, and upon successfully reading the two-dimensional code for a gas consumption facility or a gas supply facility, transmits the read two-dimensional code data to the gas management server 101. The menu display application downloads customer data created by the gas management server 101 to display the downloaded data on a screen, and when the safety inspector provides an input according to the menu display, checks and transmits the input data to the gas management server 101.

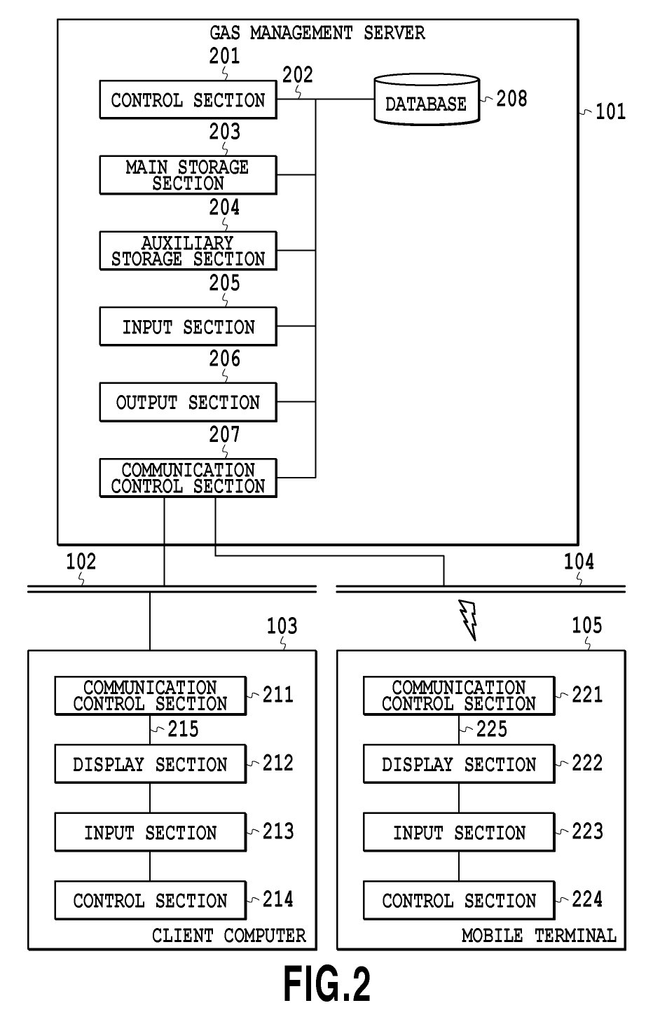

Now, with reference to a block diagram in FIG. 2, the configuration of the above-described gas management system will be described in detail. The gas management server 101 includes a control section 201, a main storage section 203, an auxiliary storage section 204, an input section 205, an output section 206, a communication control section 207, and a database 208, and these elements are coupled together via a system bus 202.

The control section 201 is also referred to as a central processing unit (CPU) and controls each of the above-described components and calculates data. The control section 201 also reads each of various programs stored in the auxiliary storage section 204 into the main storage section 203 to execute the program. The main storage section 203 is also referred to as a main memory and stores input data received by the gas management server 101, computer executable instructions, data resulting from calculation processes in accordance with the instructions, and the like.

The auxiliary storage section 204 is typified by a hard disk (HDD) and is used to store data and programs on a long-term basis. The main storage section 203 has a relatively small storage capacity compared to the auxiliary storage section 204 and is thus used for temporary data storage and calculation processes, whereas the auxiliary storage section 204 is used to store and save needed data and information on a long-term basis. In other words, the control section 201, when executing a program to calculate data, reads needed data and program from the auxiliary storage section 204 into the main storage section 203, and writes data resulting from calculations to the auxiliary storage section 204 in order to store and save the data resulting from the calculations on a long-term basis. The database 208 includes data tables for a staff member data table, a customer data table, an operation unit price data table, an operation cost data table, and a sales office data table described below.

The client computer 103 connected via the network 102 includes a communication control section 211, a display section 212, an input section 213, and a control section 214 coupled together via a system bus 215, and exchanges information with the gas management server 101 via the communication control section 211.

The display section 212 displays an input interface screen provided by the gas management system, and the staff member in the sales office inputs a request to output a payment notice via the input interface screen. The input request is transmitted to the gas management server 101 via the communication control section 211 and temporarily stored in the main storage section 203 or the auxiliary storage section 204.

The mobile terminal 105 connected via the network 104 includes a communication control section 221, a display section 222, an input section 223, and a control section 224 connected together via a system bus 225, and exchanges information with the gas management server 101 via the communication control section 221.

The display section 222 displays an input interface screen provided by the gas management system, and the safety inspector inputs the content of a safety operation via the input interface screen. The input data is transmitted to the gas management server 101 and temporarily stored in the main storage section 203 or the auxiliary storage section 204.

The input section 223 receives the read two-dimensional code via the input interface screen displayed on the display section 222. The received two-dimensional code is converted into digital data, which is transmitted to the gas management server 101.

The control section 224 performs a process of switching the input interface screen displayed on the display section 222 based on data transmitted by the gas management server 101.

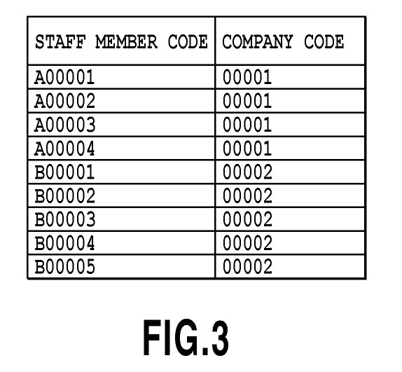

FIG. 3 is a diagram depicting an example of the staff member data table of the gas management system according to the present invention. The staff member data table stores information on the safety inspector who performs the safety operation. In the embodiment, the staff member data table includes a “staff member code” used to identify a staff member and a “company code” used to identify a commissioned company to which the staff member belongs.

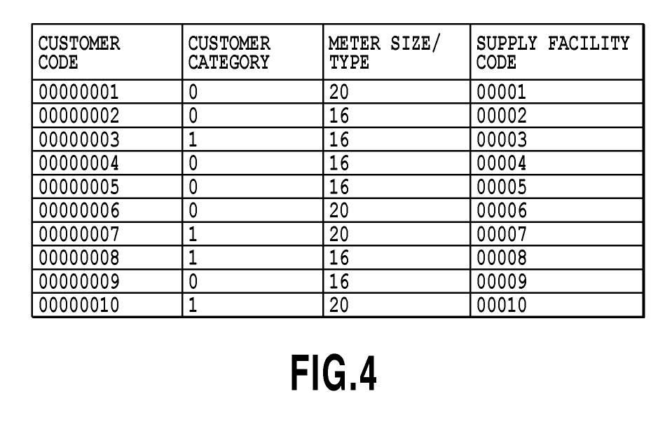

FIG. 4 is a diagram depicting an example of the customer data table of the gas management system according to the present invention. The customer data table stores information on customers related to the safety operation. In the embodiment, the customer data table includes a “customer code” used to identify a customer, a “customer category” that is indicative of the gas supply method for the customer (indicating whether the customer facility (gas consumption facility) is compliant with the Liquefied Petroleum Gas Act or the Gas Business Act), a “meter size and type”, and a “supply facility code” used to identify a gas supply facility paired with a gas customer facility (gas consumption facility). The safety inspector performs the safety operation for the identified gas supply facility. The “customer category” is set to “0” when the gas customer facility (gas consumption facility) is compliant with the Liquefied Petroleum Gas Act, that is, when the gas customer facility is a facility in a general supply method or a concentric gas supply method, and to “1” when the gas customer facility is compliant with the Gas Business Act, that is, when the gas customer facility is in a community gas supply method. Furthermore, the “meter size and type” is used to identify the size and type of the meter owned by the customer because the operation unit price of the safety operation is different depend on the size and type of the meter, so that the size and type of the meter is needed to obtain one of the operation unit prices specified for the respective meter size and type as described below.

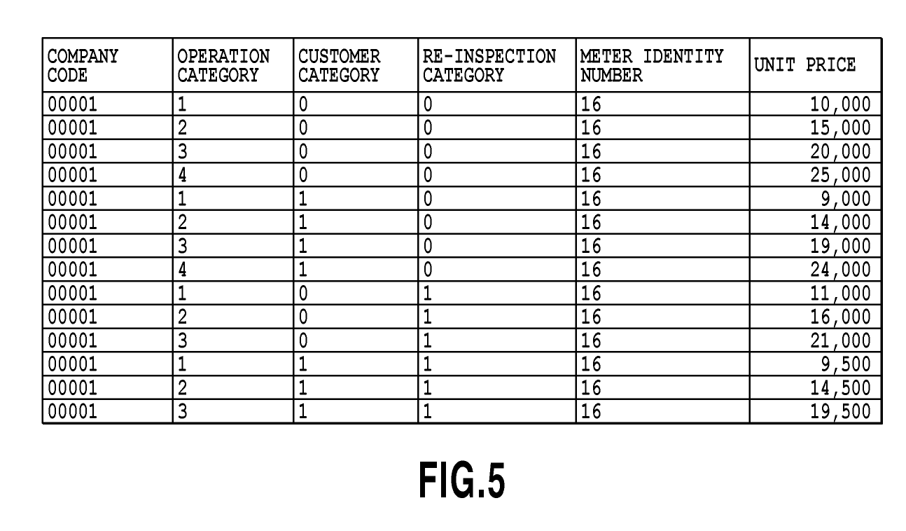

FIG. 5 is a diagram depicting an example of the operation unit price data table of the gas management system according to the present invention. The operation unit price data table stores information on the operation unit prices specified for the respective commissioned companies for the safety operation. In the embodiment, the operation unit price data table includes a “company code” used to identify the commissioned companies, an “operation category” that is indicative of a periodic inspection, a bulk inspection, or the like, a “customer category” that is indicative of the gas supply method, a “re-inspection category” that indicate, in the case of inspection, whether the inspection is a normal inspection or a re-inspection, a “meter size and type”, and a “unit price”. In other words, in the present embodiment, the operation unit price is specified for each commissioned company, for each operation category, for each customer category, for each re-inspection category, and for each meter size and type. However, the present embodiment is not limited to such a configuration, but the operation unit price may be specified in any unit. The “operation category” is set to “1” for a periodic operation, to “2” for a bulk operation, to “3” for a pipeline inspection, and to “4” for an inspection-related operation. The “re-inspection category” is set to “1” for a normal inspection and to “2” for a re-inspection.

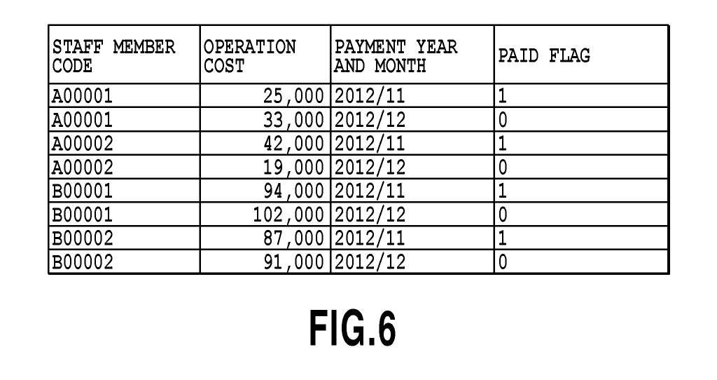

FIG. 6 is a diagram depicting an example of the operation cost data table of the gas management system according to the present invention. When the safety inspector performs the safety operation, the operation cost data table stores information on the operation cost totalized on a yearly or monthly basis by receiving an operation item from the mobile terminal 105, and calculating the operation cost based on the operation item and the operation unit price. In the embodiment, the operation cost data table includes a “staff member code”, an “operation cost”, a “payment year and month”, and a “paid flag” that indicates whether payment has been made in the year and month. For example, for the operations performed in December, 2012, the safety inspector calculates the operation cost of each operation based on the unit price included in a record in the operation unit price data table, and adds the calculated operation cost to the “operation cost” in the record labeled a “payment year and month” of December, 2012. In January, 2013, a new record labeled a “payment year and month” of January, 2013 is created, and the operation cost of each operation is added to the “operation cost” in the record.

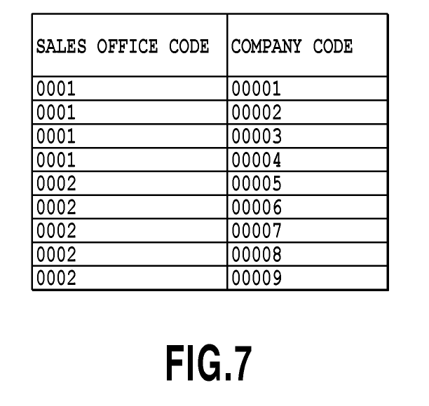

FIG. 7 is a diagram depicting an example of the sales office data table of the gas management system according to the present invention. The sales office data table stores information on sales offices. In the embodiment, the sales office data table includes a “sales office code” used to identify a sales office and a “company code” used to identify a commissioned company under the control of the sales office.

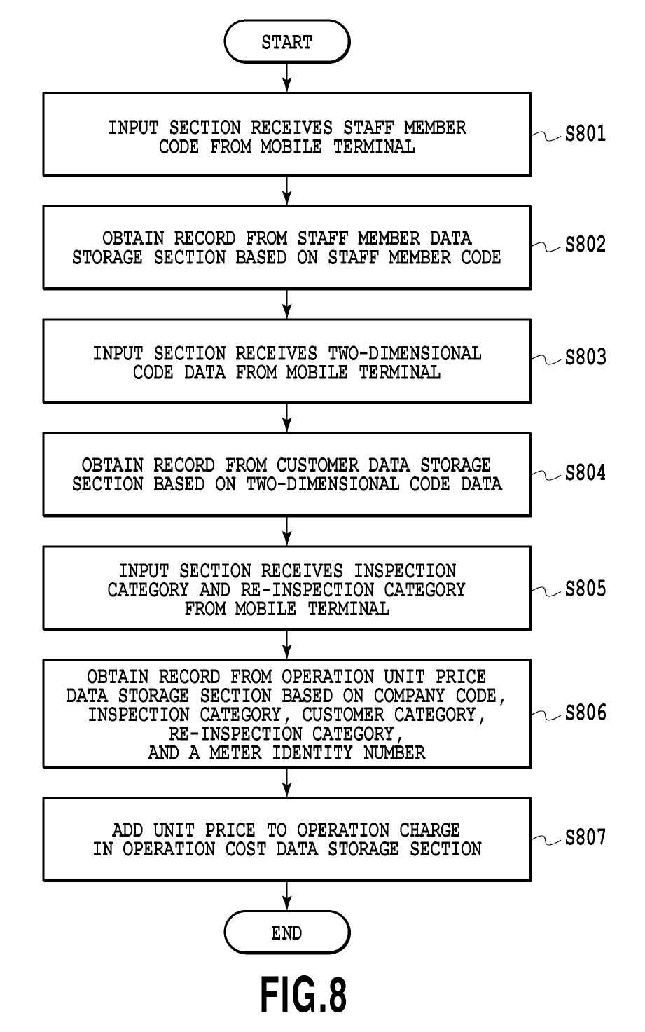

Now, with reference to FIG. 8, an operation cost calculating process performed by the gas management server 101 in accordance with a safety operation item input by the safety inspector in performing the safety operation will be described according to the embodiment of the present invention.

First, in step 801, an input interface screen that accepts an input of a staff member code is displayed on a display section 222 of the mobile terminal 105. The safety inspector inputs the staff member code assigned to the safety inspector via the input interface screen. The input staff member code is transmitted to the gas management server 101 and received by the input section 205 (step 801).

Then, the control section 201 uses the received staff member code as a key to obtain the record of the staff member data on the safety inspector from the staff member data table (step 802). The record of the staff member data includes a company code used to identify the commissioned company, allowing identification of the commissioned company to which the safety inspector belongs. In the present embodiment, the safety inspector inputs the staff member code via the mobile terminal 105 to identify the staff member for the safety inspector. However, the staff member may be identified by, for example, using an individual identification number provided to the mobile terminal 105 instead of inputting the staff member code. That is, the input of the staff member code may be omitted by storing the individual identification number in the staff member data table so as to allow the individual identification number to be automatically transmitted to the gas management server 101.

Then, in step 803, an input interface screen that allows a two-dimensional code to be read is displayed on the display section 222 of the mobile terminal 105. It should be understood that this may be replaced with various applications as long as the two-dimensional code can be read. Then, the safety inspector uses the mobile terminal 105 to read the two-dimensional code attached to the gas consumption facility 106. The two-dimensional code is converted into a digital code by the control section 224 of the mobile terminal 105. The digital code is transmitted to the gas management server 101 and receives by the input section 205 (step 803). In this regard, the received two-dimensional data code is indicative of a customer code used to identify the customer.

Then, the control section 201 uses the received two-dimensional code as a key to obtain a record in the customer data table for the customer on whom the safety operation is to be performed (step 804). Since the record in the customer data table includes the “customer category” that is indicative of the gas supply method of the customer and the “meter size and type” of the installed meter, the customer category and the meter size and type can be identified which are needed to obtain the operation unit price described below.

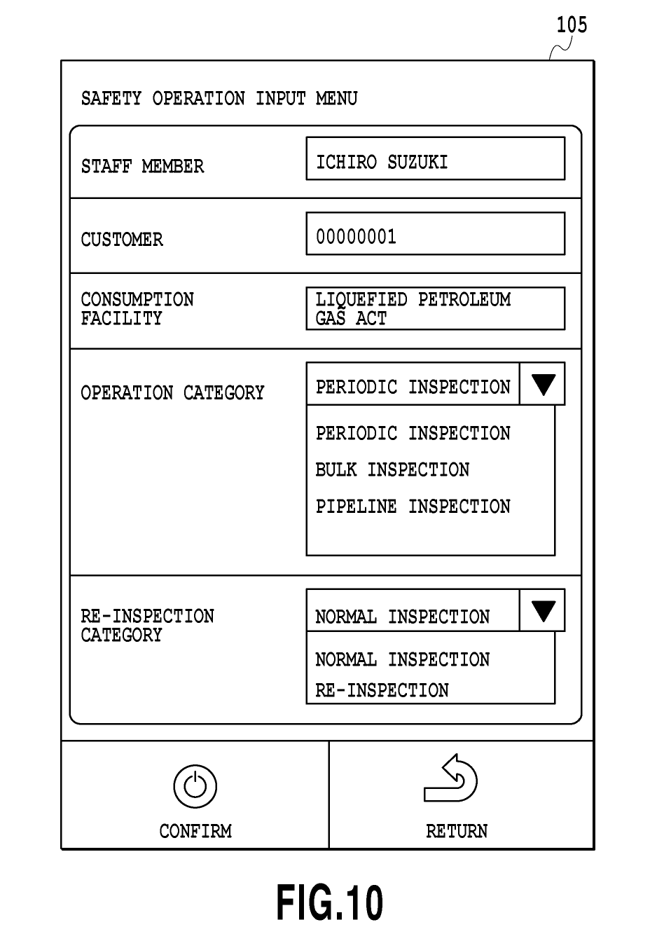

Then, in step 805, an input interface screen that accepts the input of the safety operation item is displayed on the display section 222 of the mobile terminal 105. The input interface screen allows the input of information identifying the content of the safety operation performed by the safety inspector. In the present embodiment, obtainment of a record in the operation unit price data table described below needs the input of the operation category of the safety operation (a periodic inspection, a bulk inspection, a pipeline inspection, and an inspection-related operation) performed by the safety inspector and of information indicating whether or not the operation is a re-operation. To allow that information to be identified, the input interface screen displayed on the display section 222 of the mobile terminal 105 may be configured to accept selections for the operation category and the re-inspection category displayed in a pull-down form, as depicted in FIG. 10. The safety inspector selects the operation category and the re-inspection category from the pull-down menu displayed on the display section 222 of the mobile terminal 105, and depresses a “confirm” button depicted in FIG. 10. That information is then transmitted to the gas management server 101 and received by the input section 205 (step 805). The input content of the safety operation is not limited to this. For example, for a replacement operation, a code identifying a replacement part may be input or replacement parts may be displayed in a pull-down form so that a selected replacement part can be accepted. In this case, columns for a “replacement part code” and the like are also added to records in the operation unit price data table so as to allow the operation unit price to be determined for each replacement part.

Then, the control section 201 uses, as keys, the company code included in the record obtained from the staff member data table in step 802, the customer category and meter size and type included in the record obtained from the customer data table in step 804, and the operation category and re-inspection category received in step 805 to obtain, from the operation unit price data table, a record in the operation unit price data table which is indicative of the operation unit price of the safety operation (step 806).

Then, the control section 201 uses, as keys, the staff member code received in step 801 and the year and month in a timestamp from the gas management server 101 to obtain a record in the operation cost data table and add, to the operation cost included in the obtained record, the value of the “unit price” included in the record obtained from the operation unit price data in step 806, thus updating the operation cost data table (step 807). In this regard, such an update process is expected to use, for example, an UPDATE statement in SQL statements, but the use of the UPDATE statement for addition of the unit price needs the presence of a recoded obtained using the staff member code and the year and month as keys. If the record fails to be obtained (if, for example, the operation is performed for the first time in the next month or a new safety inspector performs the safety operation), a new record with the staff member code for the safety inspector, the year and month, and the above-described unit price set therein may be inserted into the operation cost data table (the other columns remain at the initial values).

With reference to FIGS. 5 and 6, a specific example of the present step will be described. It is assumed that a safety inspector with a staff member code of “A00001” conducts two inspections in November, 2012, that is, a periodic inspection (inspection category of “1”) with a gas consumption facility in the concentric gas supply method (customer category of “0”), a normal inspection (re-inspection category of “0”), and a meter size and type of “16” (first inspection) and a bulk inspection (inspection category of “2”) with a gas consumption facility in the concentric gas supply method (customer category of “0”), a normal inspection (re-inspection category of “0”), and a meter size and type of “16” (second inspection). As seen in FIG. 5, the operation unit price of the first inspection is 10,000 yen, and the operation unit price of the second inspection is 15,000 yen. Then, in processing in step 807, at the time of the first inspection, a new record with a staff member code of “A00001” is created in the operation cost data table (November, 2012 is set in the “payment year and month”), and 10,000 yen is set in the “operation cost”. At the time of the second inspection, 15,000 yen is added to the “operation cost” in the record, and the operation cost in the record in the operation cost data table is 25,000 yen.

The example is an illustration of when the safety inspector performs the safety operation, the unit price of the safety operation is automatically calculated. According to the present invention, when the safety inspector simply receives the staff member code from the mobile terminal 105, reads the two-dimensional code, and inputs the operation category and the re-inspection category, the unit price of the safety operation is automatically calculated and dates of operations are added up in year and month units for management. This eliminates the need for manual calculation of the unit price as in the related art, and also prevents the operation cost from being erroneously calculated during the totalizing operation. Furthermore, since the operation cost is calculated in response to the safety inspector's depression of the confirm button, possible mistakes can be prevented such as omission of report of the content of the operation resulting from the time difference between the end of the safety inspector's safety operation and the calculation of the date of the operation.

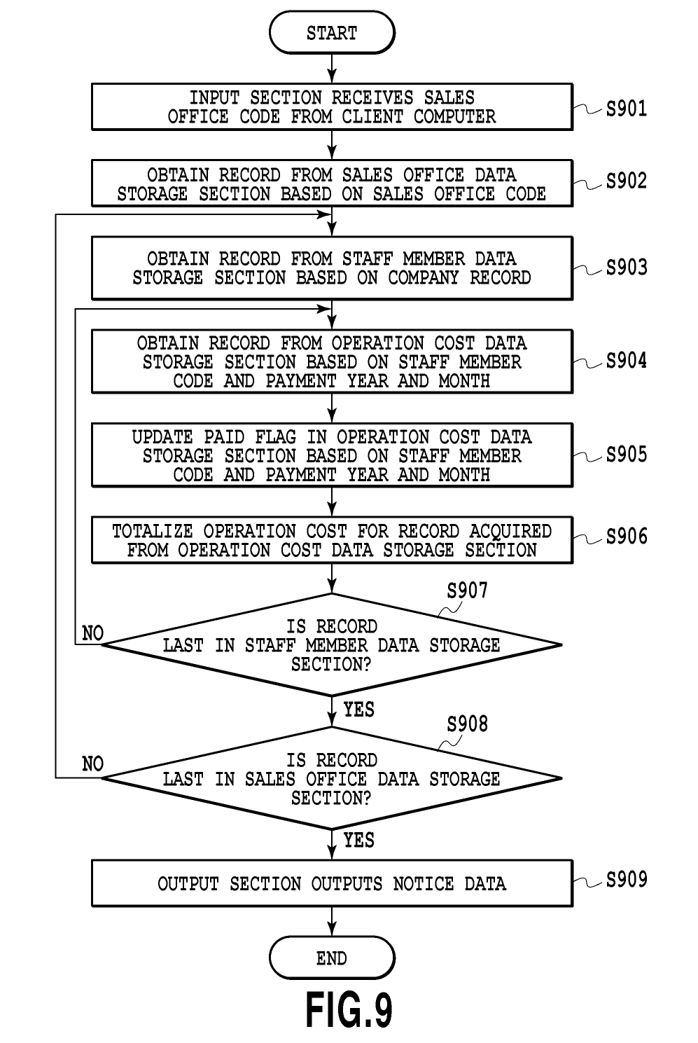

Now, with reference to a flowchart in FIG. 9, an example will be described in which a payment notice is output when the staff member in the sales office pays the operation cost to the commissioned company.

First, in step 901, an input interface screen that accepts a request to output a payment notice is displayed on the display section 212 of the client computer 103, and the staff member in the sales office inputs the sales office code via the input interface screen. In the present embodiment, the input of the sales office code is accepted via the client computer 103. However, the input of the sales office code need not necessarily be performed. For example, a database may be provided in which the IP address of the client computer 103 is associated with the sales office code so that, when the request to output a payment notice is input via the input interface screen, the IP address of the client computer 103 is automatically obtained to identify the sales office code. The input sales office code is transmitted to the gas management server 101 and received by the input section 205 (step 901).

Then, the control section 201 uses the received sales office code as a key to obtain a record from the sales office data table (step 902).

Then, the control section 201 uses, as a key, the company code included in the record obtained from the sales office data table instep 902, to obtain a record from the staff member data table (step 903). As described above, when data is obtained from the sales office data table in which information indicative of the sales offices and the commissioned companies in association with one another is stored and data is also obtained from the staff member data table in which each commissioned company is associated with the safety inspectors from the commissioned company, all the safety inspectors belonging to the commissioned companies under the control of the sales office can be identified simply by inputting the sales office code.

Then, the control section 201 uses, as keys, the staff member code included in the record obtained from the staff member data table in step 903 and the year and month in the timestamp from the gas management server 101, to obtain a record from the operation cost data table (step 904). In this regard, when a plurality of records are obtained from the staff member data table in step 903, a record is obtained from the operation cost data table for each of the staff member codes included in the respective records obtained from the staff member data table.

Then, the control section 201 updates the value of a “paid flag” included in the record obtained from the operation unit price data table in step 904, to “1: paid” (step 905). In the present embodiment, the present update process is performed in each time of obtaining a record from the operation cost data table for each staff member in step 904. However, the records may be updated at a time after the payment notice described below is output.

Then, the control section 201 totalizes the operation costs included in the records obtained from the operation cost data table in step 904 (step 906). In this regard, the totalization of the operation cost is performed for each commissioned company, and thus, when a plurality of records are obtained from the staff member data table in step 903, the process returns to step 904 to repeat obtainment of a record from the staff member data table in accordance with the number of the records from the staff member data table (step 907).

When, in step 907, the totalization of the operation costs for all the safety inspectors from one of the commissioned companies ends, the process returns to step 903 to use the company code included in the next record in the sales office data table, as a key, to obtain a record from the staff member data table. Then, processes of steps 904 to 907 are repeated until all the records obtained from the sales office data table in step 902 are read (step 908). With reference to FIGS. 3, 6, and 7, a specific example of the cost calculating process in the present process will be described. It is assumed that a staff member in a sales office with a sales office code of “0001” outputs a payment notice in December, 2012. Using the sales office code “0001”, three records can be obtained from the sales office data table (records with company codes “00001”, “00002”, and “00003”) (see FIG. 7). Using the company code “0001”, four records can be obtained from the staff member data table (records with staff member codes “A00001”, “A00002”, “A00003”, and “A00004”) (see FIG. 3). Using the staff member code “A00001” and the payment year and month “December, 2012”, one record is obtained from the operation cost data table (the operation cost is 33,000) (see FIG. 6). When the record can be obtained, the paid flag for the record is updated to “1”. Then, using the staff member code “A00002” and the payment year and month “December, 2012”, a record is obtained from the operation cost data table (the operation cost is 19,000). No record for the staff member code “A00003” is present in the operation cost data table, and thus, 33,000 yen and 19,000 yen are totaled to determine the payment to the commissioned company with the company code “00001” to be 52,000 yen. Thus, a similar process is repeated for the company codes “00002” and “00003”.

Finally, the control section 201 passes data (such as operation costs totalized in step 906 and the commissioned company codes) to the output section 206, and the output section 206 outputs payment notice data based on the passed information (step 909). The payment notice data may be transmitted to a printer or the like (not depicted in the drawings) connected to the gas management server 101 so that the printer can print the payment notice data.

The example illustrates where the payment notice is output when the staff member in the sales office pays the operation cost to the commissioned company. According to the present invention, when the staff member in the sales office simply inputs the sales office code, the operation costs for the safety inspectors from all the commissioned companies under the control are automatically totalized and payment notices are created. This eliminates the need for manual calculation of the operation cost as in the related art, and also prevents the operation cost from being erroneously calculated during the totalizing operation. Furthermore, when the payment notice is output, the paid flag” in the operation cost data table is updated. This enables determination of whether or not the payment notice to the commissioned company has been output and further prevents such a mistake in which a duplicate payment notice is output. In the present embodiment, the sales office code is input to allow totalization of the operation costs for all the commissioned companies associated with the sales office code. However, the company code of each commissioned company may be input via the client computer 103 to allow the payment notice to be issued to the commissioned company.

Furthermore, the specific data structure is not limited to the embodiment but may be changed.

1. A computer system for calculating a cost of a gas safety operation to be paid by a gas supplier, the system comprising a gas management server, a mobile terminal and a printer connected to the gas management server, and a gas supply facility owned by a gas customer who receives a gas supply, and the gas supply facility incorporating a meter identification code, the meter identification code encoding a customer identification code corresponding to the gas customer, the system comprising:
the mobile terminal configured to:
read the meter identification code attached to the gas supply facility to accept the customer identification number;
accept an operator identification number corresponding to the safety operator and gas safety operation information corresponding to the gas safety operation input via a display screen of the mobile terminal, the gas safety operation to be performed by a safety operator;
display the accepted customer identification number and the accepted gas safety operation information on the display screen;
the gas supply facility configured to accept the gas safety operation to be performed based on the displayed customer identification number and the displayed gas safety operation information;
the gas management server configured to:
receive the operator identification number, the customer identification number, and the gas safety operation information from the mobile terminal;
obtain operator information from a database based on the received operator identification number, the operator information including the operator identification number and an operator organization identification number corresponding to an operator organization to which the safety operator belongs;
obtain customer information from the database based on the received customer identification number, the customer information including the customer identification number, a customer category indicative of a gas supply method for the gas customer and a gas meter size and type;
obtain operation unit price information from the database based on the received gas safety operation information, the obtained operator information, and the obtained customer information, the operation unit price information including a gas safety operation unit price specified for each the operator organization, for each content of the gas safety operation, for each the customer category, and for each the meter size and type;
update operation cost information stored in the database based on the obtained operator information and the obtained operation unit price information, the operation cost information including a gas safety operation cost to be paid to the operation organization by the gas supplier; and
totalize the gas safety operation cost from the updated operation cost information stored in the database based on the operation cost information for each the operation organization based on the obtained operator information; and
the printer configured to output payment notice data including the totalized gas safety operation cost.

2. The computer system according to claim 1, further comprising a client computer located in a gas supplier organization belonging to the gas supplier, wherein the gas management server is further configured to:
receive a gas supplier organization identification number from the client computer;
obtain gas supplier organization information from the database based on the received gas supplier organization identification number, the gas supplier organization information including the gas supplier organization identification number and the operator organization identification number; and
totalize the gas safety operation costs from the updated operation cost information for each the gas supplier organization based on the obtained operator information and the obtained gas supplier organization information,
wherein the client computer is configured to:
receive the totalized gas safety operation cost for each gas supplier organization from the gas management server; and
output the received totalized gas safety operation cost.
